(19) United States
(12) Patent Application Publication
(10) Pub. No.: US 2013/0217274 A1
(43) Pub. Date: Aug. 22, 2013

(54) CONNECTOR FOR ACHIEVING COMPLETE INTEROPERABILITY BETWEEN DIFFERENT TYPES OF DATA AND MULTIMEDIA INTERFACES

(71) Applicant: Transwitch Corporation, (US)

(72) Inventors: Amir Bar-Niv, Sunnyvale, CA (US); Ziv Kabiry, Kfar Saba (IL); Shlomy Chaikin, Moshav Mazor (IL)

(73) Assignee: TRANSWITCH CORPORATION, Shelton, CT (US)

(21) Appl. No.: 13/852,559

(22) Filed: Mar. 28, 2013

Related U.S. Application Data
(63) Continuation-in-part of application No. 13/312,514, filed on Dec. 6, 2011.
(60) Provisional application No. 61/617,816, filed on Mar. 30, 2012.

(51) Int. Cl. H01R 27/00

(52) U.S. Cl. CPC H01R 27/00
USPC 439/676

(57) ABSTRACT

A universal connector for enabling interoperability between different types of data interfaces and multimedia interfaces comprises a housing; and a plurality of contact pins arranged in the housing, wherein the plurality of contact pins provide connectivity for multimedia display interface signals and data interface signals, wherein the housing includes a first part and a second part coupled together, wherein the first part includes a first group of contact pins and the second part includes a second group of contact pins, wherein the first group of contact pins provides connectivity to a data interface and the second group of contact pins provides, in part, connectivity to a multimedia interface.

### CROSS REFERENCE TO RELATED APPLICATIONS

This application claims the benefit of U.S. Provisional Application No. 61/617,816 filed Mar. 30, 2012. This application is also a continuation-in-part of U.S. patent application Ser. No. 13/312,514 filed Dec. 6, 2011.

### TECHNICAL FIELD

This invention generally relates to the connectivity of handheld devices and electronic display devices.

### BACKGROUND

The highz-definition multimedia interface (HDMI) is a compact audio/video connector interface for transmitting uncompressed digital streams. The HDMI connects a digital multimedia (or audio/video) source (e.g., a set-top box, a DVD player, a personal computer, a video game console, etc.) to a compatible digital sink, such as a digital television.

A HDMI cable is a transport medium including three transition minimized differential signaling (TMDS®) channels utilized to transfer video, audio, and auxiliary data encapsulated in TDMS characters; the transmission is synchronized using a high-frequency clock signal running over a clock channel. The TDMS and clock channels are differential pairs. A HDMI cable also includes the following channels: a display data channel (DDC_SCL and DDC_SDA), a consumer electronics control (CEO), and a hot-plug detect (HPD) signal which originates at the sink. The HDMI interface is implemented using a HDMI cable and connectors, each of which includes 19 contact pins. A source and sink connector have the same configuration. Table 1 lists the pins in a type A HDMI connector (either a source or sink).

TABLE 1

| Pin Number | HDMI Signal |
|---|---|
| 1. | TMDS_Data2+ |
| 2. | Shield |
| 3. | TMDS_Data2− |
| 4. | TMDS_Data1+ |
| 5. | Shield |
| 6. | TMDS_Data1− |
| 7. | TMDS_Data0+ |
| 8. | Shield |
| 9. | TMDS_Data0− |
| 10. | TMDS_Clk+ |
| 11. | Shield |
| 12. | TMDS_Clk− |
| 13. | CEC |
| 14. | Utility/HEAC+ |
| 15. | SCL |
| 16. | SDA |
| 17. | DDC/CEC/Ground |
| 18. | +5 V |
| 19. | HPD/HEAC− |

DisplayPort™ (or DP) is another example for a standard that defines a digital display interface of a new digital audio/video interconnect. The DisplayPort is intended to be used primarily between a computer and its display monitor, or a computer and a home-theater system. The DP interface is facilitated using a proprietary cable and connectors, each of which includes 20 contact pins. The DP cable is a cross cable, i.e., each of the source and sink connectors has a different configuration.

In a typical configuration, transport channels of a DisplayPort interface include a main link, an auxiliary channel (AUX), and a hot plug detect (HPD). The main link is a unidirectional channel that allows data transfers over up to 4 lanes which carry clock signals in addition to the video/audio streams. Each lane is an AC-coupled differential pair. The auxiliary channel is a bi-directional half-duplex channel that carries control and management information and the HPD channel is used by a sink device to interrupt a source device when a plug is connected or disconnected.

The DisplayPort interface is facilitated using a proprietary cable and connectors, each of which includes 20 pins. The DisplayPort cable is a cross cable, i.e., each of a source and sink connector has a different configuration. Table 2 lists the pins and their signals of source and sink DisplayPort connectors.

TABLE 2

| | DisplayPort | DisplayPort |
|---|---|---|
| Pin Number | Source | Sink |
| 1. | ML_lane0P | ML_lane3N |
| 2. | GND | GND |
| 3. | ML_lane0N | ML_lane3P |
| 4. | ML_lane1P | ML_lane2N |
| 5. | GND | GND |
| 6. | ML_lane1N | ML_lane2P |
| 7. | ML_lane2P | ML_lane1N |
| 8. | GND | GND |
| 9. | ML_lane2N | ML_lane1P |
| 10. | ML_lane3P | ML_lane0N |
| 11. | GND | GND |
| 12. | ML_lane3N | ML_lane0P |
| 13. | Config1 | Config1 |
| 14. | Config2 | Config2 |
| 15. | AUX_CHP | AUX_CHP |
| 16. | GND | GND |
| 17. | AUX_CHN | AUX_CHN |
| 18. | HPD | HPD |
| 19. | Return | Return |
| 20. | AUX_PWR | AUX_PWR |

The Universal Serial Bus (USB) standard is primarily utilized to establish communication between devices and a host controller of a PC. The USB can connect computer peripherals, such as mice, keyboards, digital cameras, printers, personal media players, flash drives, network adapters, external hard drives, and the like. The USB was designed for personal computers, but it has become commonplace on handheld devices, such as mobile phones, smartphones, PDAs, tablet computers, and video game consoles. The USB can also serve as a power cord for charging such devices.

For many types of handheld devices, the USB has become the only standard interface. The various USB protocols support different transmission rates for data. For example, data transmission rates of USB 2.0 can be 1.5 Mbps (Low speed), 12 Mbps (Full Speed), and High speed (480 Mbps). The USB 3.0 standard defines a higher speed data transmission rate of 5 Gbps, and therefore can be utilized as a database for mass storage devices and the like.

There are several types of USB connectors. The most common connectors for handheld devices are micro USB 5-pin Standard-AB plugs and receptacles. Typically, the USB connectors in the Standard-AB plug are recessed in the plug, thereby allowing the power to be connected first, thus preventing data errors by allowing the device to power up first and then transfer data. The pin out of a standard-micro USB 2.0 AB plug and receptacle is detailed in Table 3.

TABLE 3

| Pin Number | Pin Name | Function |
|---|---|---|
| 1. | VBUS | Power |
| 2. | D− | USB 2 Diff pair |
| 3. | D+ | |
| 4. | ID | Type of connection |
| 5. | GND | Ground for power return |
| | Shield | |

Another popular connector is a standard AB micro USB 3.0 10-pin connector, the pin out of which is provided in Table 4.

TABLE 4

| Pin Number | Pin Name | Function |
|---|---|---|
| 1. | VBUS | Power |
| 2. | D− | USB 2 Diff pair |
| 3. | D+ | |
| 4. | ID | Keying |
| 5. | GND | Ground for power |
| | | return |
| 6. | MicB_SSTX− | Super speed RX diff |
| 7. | MicB_SSTX+ | pair |
| 8. | GND_Drain | Ground for signal |
| | | return |
| 9. | MicB_SSRX− | Super speed TX diff |
| 10. | MicB_SSRX+ | pair |
| | Shield | |

As can be understood there are many different types of connectors to support different types of multimedia and data interfaces. Thus, in order to design a consumer electronic device, e.g., a smart phone, a tablet computer, a DVD player, etc. that supports multiple different types of multimedia interfaces, such a device should be equipped with different types of connectors. For handheld devices where size is limited, this is not a desirable design solution.

In addition, handheld devices are typically equipped with only a USB connector, thus connecting such devices to a multimedia device may require a special adapter, and in many cases, such connectivity may not be feasible. For example, connecting a smart phone equipped with a USB connector to a projector having a HDMI connector currently is not feasible. Another example is that a smart phone equipped with an HDMI connector, which is used to transmit video/audio to an external display, cannot transmit or receive data, and thus an additional connector of a USB type is required for that purpose. Certain handled devices provided by Apple Computers®, e.g., iPhone® and iPAD® include a single proprietary connector. However, even such a connector is not compatible with standard multimedia interfaces, such as HDMI, DP, and the like, without having a special adaptor.

Thus, a connector design that would enable interoperability between different types of multimedia interfaces as well as between data and multimedia interfaces, can provide great flexibility and benefit to users of at least handheld devices.

Thus, it would be advantageous to provide a solution that would overcome the shortcomings of prior art multimedia connectivity solutions.

### SUMMARY

Certain embodiments disclosed herein include a universal connector for enabling interoperability between different types of data interfaces and multimedia interfaces. The universal connector comprises a housing; and a plurality of contact pins arranged in the housing, wherein the plurality of contact pins provide connectivity for multimedia display interface signals and data interface signals, wherein the housing includes a first part and a second part coupled together, wherein the first part includes a first group of contact pins and the second part includes a second group of contact pins, wherein the first group of contact pins provides connectivity to a data interface and the second group of contact pins provides, in part, connectivity to a multimedia interface.

Certain embodiments disclosed herein also include a cable constructed to enable interoperability between different types of data interfaces and multimedia interfaces. The cable comprises a universal connector including a plurality of contact pins providing connectivity for multimedia display interface signals and data interface signals, wherein a plurality of contact pins are arranged in a housing, wherein the plurality of contact pins provide connectivity for multimedia interface signals and data interface signals, wherein the housing includes a first part and a second part coupled to each other, wherein the first part includes a first group of contact pins and the second part includes a second group of contact pins, wherein the first group of contact pins provides connectivity to a data interface and the second group of contact pins provides, in part, connectivity to a multimedia interface; a first connector including a plurality of contact pins providing connectivity for any one of multimedia display interface signals and data interface signals; and a plurality of conducting wires for coupling the plurality of contact pins of the universal connector to the plurality of contact pins of the first connector.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a schematic diagram illustrating a cable that includes a universal connector according to an embodiment of the invention.

FIG. 2 is a diagram of a mechanical design of a type-B universal connector according to an embodiment.

FIG. 3 is a diagram of a mechanical design of a type-C universal connector according to an embodiment.

FIG. 4 is a schematic diagram illustrating a Y-type cable utilized for simultaneous transmission of data and multimedia signals according to one embodiment.

### DETAILED DESCRIPTION

It is important to note that the embodiments disclosed by the invention are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

In accordance with certain embodiments disclosed herein, a connector (hereinafter the “universal connector”) is provided. The universal connector is designed to allow interoperability between different types of multimedia interfaces and between multimedia interfaces and a data interface. A connection between a device having a universal connector to a device having a USB, a HDMI, a DisplayPort, or a universal connector can be achieved using the disclosed cable and connectors.

The universal connector is realized through an electronic design and mechanical design. The electrical design determines the number of contact pins and the functionality of each pin to allow interoperability with the different types of interfaces. The mechanical design determines the shape and structure of the housing (chassis) in which the pins are arranged. The various embodiments of the electrical and mechanical designs of the universal connector are discussed in greater detail below.

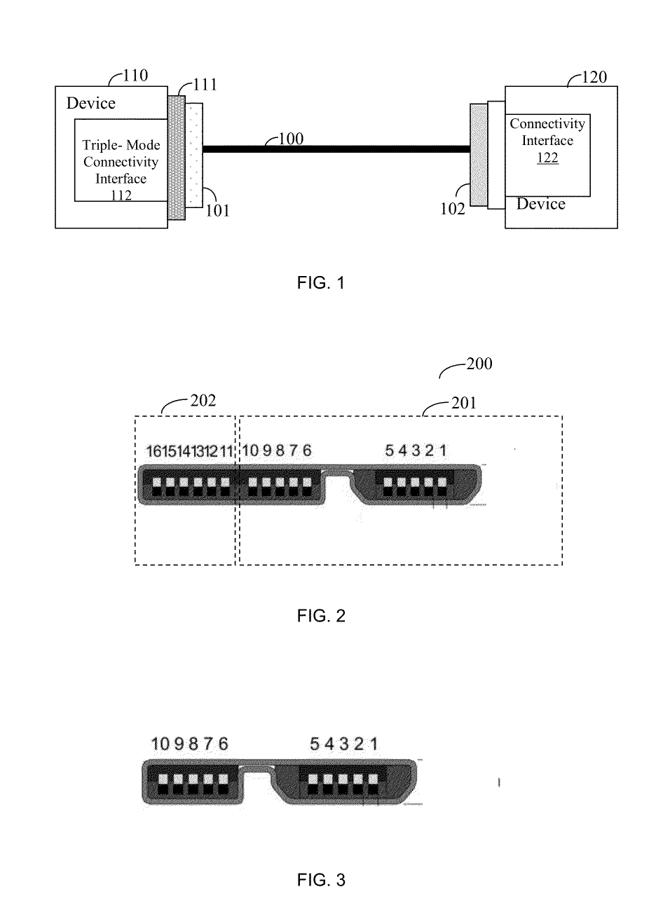

FIG. 1 illustrates a cable 100 constructed according to one embodiment. The cable 100 includes, at one end, a universal connector 101 and, at the other end, a standard connector 102. The standard connector 102 may be a HDMI connector, a DisplayPort® connector, and a USB connector depending on the type of a connectivity interface 122 in a device 120.

In one embodiment, the cable 100 connects between a source device 110 and a sink device 120. The device 110 may be a handled device, including but not limited to, a mobile phone, a smart phone, a laptop computer, a tablet computer, a personal digital assistant (PDA), a camcorder, and the like. The device 110 may also include other consumer electronic devices, such as a DVD player, a set-top box, a personal computer, a video game console, and the like. The sink device 120 may be a digital television.

The cable 100 enables a proper connection between the source device 110 and sink device 120. The device 110 includes a triple-mode connectivity interface 112. The triple-mode connectivity interface 112 is a physical layer interface capable of processing HDMI, DisplayPort, USB3, and USB2 signals, depending on the type of interface 122. For example, if the type of the interface 122 is HDMI, then the triple-mode connectivity interface 112 is configured to process HDMI signals.

In accordance with one embodiment, the triple-mode connectivity interface 112 can be programmed manually to process a HDMI, DisplayPort or USB mode of operation. According to another embodiment, the triple-mode connectivity interface 112 implements an automatic recognition mechanism for determining the type of the multimedia interface connected at the other end of the cable 100, and configures the respective device accordingly. For example, if the device 120 supports a USB, the triple-mode connectivity interface 112 recognizes that USB data is transmitted by the device 120, and sets the device 110 to process such type of data. Thus, the cable 100 provides a transport medium between two different types of interfaces. It should be noted that the connector 102 may also be a universal connector. An exemplary implementation for the automatic recognition mechanism is disclosed in the co-pending application Ser. No. 13/312,514, referenced above.

The device 110 also includes a universal connector 111 that is connectable to the universal connector 101 at the cable 100. For example, the universal connector 111 at connector 110 may be a male-type (i.e., plug) connector while the device 110 is a female-type connector (i.e., receptacle), or vice versa.

The embodiments described herein below refer to both female-types and male-types of the universal connectors 101 and 111. According to one embodiment, the electrical design of a type-A universal connector includes 16 contact pins to support the functionality of the HDMI, DisplayPort and USB3 interfaces. Exemplary table 5 lists the pins of the type-A universal connector and their signals for DisplayPort, USB2, USB3, and HDMI interfaces.

TABLE 5

| Universal | DP and | |
|---|---|---|
| Connector | USB3 | |
| pins | interfaces | HDMI Interface |
| 1 | DP_D_ChA+/− | HDMI_D_ChC+/− |
| 2 | DP_D_ChA+/− | HDMI_D_ChC+/− |
| 3 | DP_D_ChB+/− | HDMI_D_ChB+/− |
| 4 | ID | ID |
| 5 | DP_D_ChB+/− | HDMI_D_ChB+/− |
| 6 | USB3_SSTX− | HDMI_D_ChA+/− |
| 7 | USB3_SSTX+ | HDMI_D_ChA+/− |
| 8 | USB3_SSRX− | HDMI_Clk+/− |
| 9 | USB3_SSRX+ | HDMI_Clk+/− |
| 10 | USB2_D+ | USB2_D+ |
| 11 | USB2_D− | USB2_D− |
| 12 | AUX+/− | DDC_data |
| 13 | AUX+/− | DDC_clk |
| 14 | GND | GND |
| 15 | VBus | VBus |
| 16 | Reserved/GND | CEC |
| shell | GND | GND |

The type of interface in Table 5 is the type of connector at the device 120 (at the other end of the cable 100). The table lists the signal at each pin of the universal connector at the different interface types. For example, pins 1 and 2 of the universal connector provide connectivity to DisplayPort signals DP_D_ChA+/− and DP_D_ChA+/− enabling interoperability with a DisplayPort-type connector 102. As noted above, over the DisplayPort channels video/audio streams and clock signals are transferred. In addition, pins 1 and 2 of the universal connector 101 provide connectivity for HDMI D ChC+/− and HDMI D ChC+/− signals enabling interoperability with a HDMI-type connector 102.

In one embodiment, using the type-A universal connector, the USB 3.0 and DisplayPort (DP) signals can be simultaneously transferred as detailed in Table 5.

Specifically, pins 1, 2, 3, and 5 transport DisplayPort signals of the DisplayPort channels while pins 6, 7, 8, and 9 provide connectivity for USB 3.0 signals.

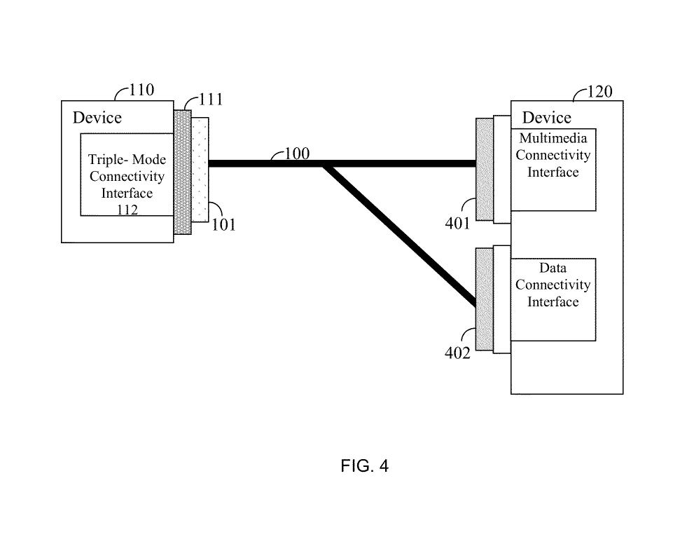

As further detailed in FIG. 4, using the type-A universal connector, the USB2 simultaneously transports over the cable 100 together with multimedia signals, such as HDMI or DisplayPort signals.

In accordance with another embodiment, a type-B universal connector is disclosed. In this embodiment, the type-B connector is designed to include 16 contact pins to support data interfaces including USB 3.0 as well as multimedia interface including a DisplayPort interface. Alternatively, the type-B connector supports USB2 and a multimedia interface, such as a HDMI interface. Specifically, each pin in the universal connector 101 serves a different function depending on the type of the connectivity of the device to which the universal connector is connected. Table 6 lists the pins of the universal connector and their signals of USB 3.0, USB 2.0, HDMI and DisplayPort interfaces.

TABLE 6

| Universal | USB3 or USB2 | DP and USB3 | HDMI and USB2 |
|---|---|---|---|
| controller pins | interface | interfaces | interfaces |
| 1 | VBus | VBus | VBus |
| 2 | D− | D− | D− |
| 3 | D+ | D+ | D+ |
| 4 | ID | ID | ID |
| 5 | GND | GND | GND |
| 6 | USB3_SSTX− | USB3_SSTX− | HDMI_D_ChA+/− |
| 7 | USB3_SSTX+ | USB3_SSTX+ | HDMI_D_ChA+/− |
| 8 | GND | HPD | HPD |
| 9 | USB3_SSRX− | USB3_SSRX− | HDMI_Clk+/− |
| 10 | USB3_SSRX+ | USB3_SSRX+ | HDMI_Clk+/− |
| 11 | | DP_D_ChA+/− | HDMI_D_ChB+/− |
| 12 | | DP_D_ChA+/− | HDMI_D_ChB+/− |
| 13 | | DP_D_ChB+/− | HDMI_D_ChC+/− |
| 14 | | DP_D_ChB+/− | HDMI_D_ChC+/− |
| 15 | | AUX+/− | DDC_clk |
| 16 | | AUX+/− | DDC_data |
| Shell | | GND | GND |

Using the type-B universal connector, USB 3.0 and DisplayPort signals can be simultaneously transferred as detailed in the “DP and USB3 interfaces” column of Table 6. Specifically, the first 10 pins are utilized to provide connectivity for USB 3.0 signals, while the last 6 pins (pins 11-16) provide connectivity to DisplayPort signals.

In addition, the type-B universal connector allows transferring HDMI and USB2 simultaneously to the other end as detailed in the “HDMI and USB2 interfaces” column of Table 6. For example, pins 6, 7 and 11-14 provide connectivity for HDMI signals over the three HDMI channels, while pins 2-3 provide connectivity for USB 2.0 data. Thus, data and multimedia signals (e.g., video) can be simultaneously transferred over a cable equipped with the type-B universal connector.

According to an embodiment, the mechanical design of the type-B universal connector including the 16 pins is illustrated in FIG. 2. A type-B universal connector 200 includes two parts connected together using a standard micro USB3 connector 201 and an extension connector 202 including the last 6 pins, i.e., pins 11-16. In a non-limiting example, the extension part 202 has a rectangular shape as illustrated in FIG. 2. The first part and the second parts are enclosed in the same connector's housing and share the same chassis.

In accordance with another embodiment, a type-C universal connector is disclosed. In this embodiment, the type-C connector is electrically designed to include 10 pins to support data interfaces USB 3.0 and USB 2.0 or a multimedia interface including at least the DisplayPort. Specifically, each pin in the type-C universal connector serves a different function depending on the type of the connectivity of the device in which the universal connector is installed. Exemplary table 7 lists the pins of a type-C universal connector and their signals of USB 3.0, USB 2.0, and DisplayPort interfaces.

TABLE 7

| Universal | USB3 or USB2 | DP and USB2 |
|---|---|---|
| connector Pins | Interface | Interfaces |
| 1 | VBus | VBus |
| 2 | D− | D− |
| 3 | D+ | D+ |
| 4 | ID | ID |
| 5 | GND | GND |
| 6 | USB3_SSTX− | DP_D_ChA+/− |
| 7 | USB3_SSTX+ | DP_D_ChA+/− |
| 8 | GND | AUX |
| 9 | USB3_SSRX− | DP_D_ChB+/− |
| 10 | USB3_SSRX+ | DP_D_ChB+/− |
| Shell | | GND |

It should be noted that using the type-C universal connector, USB 2.0 and DisplayPort signals can be simultaneously transferred as detailed in the “DP and USB2 interfaces” column of Table 7. According to an embodiment, the mechanical design of the type-C universal connector including the 10 pins is a standard micro USB3 connector as illustrated in FIG. 3.

In accordance with another embodiment, a type-D universal connector is disclosed. In this embodiment, the type-D connector is electrically designed to include 19 contact pins to support a data interface of USB 3.0 as well as a multimedia interface including at least the DisplayPort and HDMI. Specifically, each pin in the type-D universal connector serves a different function depending on the type of the connectivity of the device to which the type-D universal connector is connected. Exemplary table 8 lists the pins of the universal connector and their signals of USB3, DisplayPort, and HDMI interfaces.

TABLE 8

| Universal | DP and USB3 | HDMI |
|---|---|---|
| Connector Pins | interfaces | Interface |
| 1 | DP_D_ChA+/− | HDMI_D_ChC+/− |
| 2 | Shield | Shield |
| 3 | DP_D_ChA+/− | HDMI_D_ChC+/− |
| 4 | DP_D_ChB+/− | HDMI_D_ChB+/− |
| 5 | HPD | HPD |
| 6 | DP_D_ChB+/− | HDMI_D_ChB+/− |
| 7 | USB3_SSTX− | HDMI_D_ChA+/− |
| 8 | ID | ID |
| 9 | USB3_SSTX+ | HDMI_D_ChA+/− |
| 10 | USB3_SSRX− | HDMI_Clk+/− |
| 11 | Shield | Shield |
| 12 | USB3_SSRX+ | HDMI_Clk+/− |
| 13 | USB2_D+ | USB2_D+ |
| 14 | USB2_D− | USB2_D− |
| 15 | AUX+/− | DDC_data |
| 16 | AUX+/− | DDC_clk |
| 17 | GND | GND |
| 18 | VBus | VBus |
| 19 | Reserved/GND | CEC |
| Shell | GND | GND |

It should be noted that using the type-D universal connector, USB 3.0 and DisplayPort signals can be simultaneously transferred as detailed in the “DP and USB3 interfaces” column of Table 8. For example, pins 7, 9 and pins 10, 12 in the type-D universal connector are respectively super speed RX differential pair and super speed TX differential pair, of the USB 3.0. The pins 1, 3, 4 and 6, in the type-D universal connector are for transferring DisplayPort signals (DP_D_ChA+/− and DP_D_ChB+/−).

It should be appreciated that the different types of universal connectors can provide complete interoperability among at least HDMI, USB 2.0, USB 3.0, and DisplayPort interfaces. Specifically, the teachings of the invention disclosed herein can be utilized to connect a DisplayPort or HDMI compliant device to a USB compliant device. Therefore, connectivity is enabled, for example, between a handheld device with a USB connector and a projector equipped with a DisplayPort connector using a cable that is equipped with a universal connector of one of the types defined in detail above.

In accordance with one embodiment, the cable 100 is designed to provide a transport medium between two devices, each of which is equipped with universal connectors. The wiring of such cable may include a connection between the respective pins at each connector.

According to another embodiment, illustrated in FIG. 4, the cable 100 is designed as a Y-type cable. In such configuration, at one end, the cable 100 includes the universal connector 101, and at the other end, a multimedia interface connector 401 and a data connector 402. The multimedia interface connector 401 may be one of a DisplayPort connector or an HDMI connector. The data connector 402 may be a USB2.0 or USB3.0 connector. The universal connector 101 may any of the type-A, type-B, and type-D connectors.

While the present invention has been described at some length and with some particularity with respect to the several described embodiments, it is not intended that it should be limited to any such particulars or embodiments or any particular embodiment. Furthermore, the foregoing describes the invention in terms of embodiments foreseen by the inventor for which an enabling description was available, notwithstanding that insubstantial modifications of the invention, not presently foreseen, may nonetheless represent equivalents thereto. All examples and conditional language recited herein are intended for pedagogical purposes to aid the reader in understanding the principles of the invention and the concepts contributed by the inventors to furthering the art, and are to be construed as being without limitation to such specifically recited examples and conditions.

What is claimed is:

1. A universal connector for enabling interoperability between different types of data interfaces and multimedia interfaces, comprising:
a housing; and
a plurality of contact pins arranged in the housing, wherein the plurality of contact pins provide connectivity for multimedia display interface signals and data interface signals, wherein the housing includes a first part and a second part coupled together, wherein the first part includes a first group of contact pins and the second part includes a second group of contact pins, wherein the first group of contact pins provides connectivity to a data interface and the second group of contact pins provides, in part, connectivity to a multimedia interface.

2. The universal connector of claim 1, wherein the first group of contact pins includes 10 pins and the second group of contact pins includes 6 pins.

3. The universal connector of claim 2, wherein first part of the connector is a universal serial bus (USB) 3.0 micro connector and the second part is a rectangular extension connector, wherein the first part and the second part share the same chassis.

4. The universal connector of claim 1, wherein the data interface connectivity provided by the first group of contact pins is of USB 3.0.

5. The universal connector of claim 1, wherein the data interface connectivity provided by the first group of contact pins is of USB 3.0 and the multimedia interface connectivity provided by the second group of contact pins is of a DisplayPort interface.

6. The universal connector of claim 1, wherein the data interface connectivity provided by the first group of contact pins is of USB 2.0 and the interface connectivity provided by the second group of contact pins is any one of: a high-definition multimedia interface (HDMI) and a USB 3.0.

7. The universal connector of claim 1, wherein the universal connector is any one of a plug and a receptacle.

8. The universal connector of claim 1, wherein the first group of contact pins includes 5 pins and the second group of contact pins includes 5 contact pins.

9. The universal connector of claim 8, wherein the data interface connectivity provided by the first group of contact pins is of USB 2.0 and the multimedia interface connectivity provided by the second group of contact pins is of a DisplayPort interface.

10. The universal connector of claim 9, wherein the first part and the second part are enclosed in a housing of a micro USB 3.0 connector.

11. A cable constructed to enable interoperability between different types of data interfaces and multimedia interfaces, comprising:
a universal connector including a plurality of contact pins providing connectivity for multimedia display interface signals and data interface signals, wherein a plurality of contact pins are arranged in a housing, wherein the plurality of contact pins provide connectivity for multimedia interface signals and data interface signals, wherein the housing includes a first part and a second part coupled to each other, wherein the first part includes a first group of contact pins and the second part includes a second group of contact pins, wherein the first group of contact pins provides connectivity to a data interface and the second group of contact pins provides, in part, connectivity to a multimedia interface;
a first connector including a plurality of contact pins providing connectivity for any one of multimedia display interface signals and data interface signals; and
a plurality of conducting wires for coupling the plurality of contact pins of the universal connector to the plurality of contact pins of the first connector.

12. The multimedia-data interface cable of claim 11, wherein the multimedia display interface signals include any one of: HDMI signals and DisplayPort signals.

13. The interface cable of claim 11, wherein the data interface signals are any of: USB 3.0 signals and USB 2.0 signals.

14. The interface cable of claim 13, wherein the first connector is any one of: a HDMI connector, a DisplayPort connector, a universal connector, and a USB connector.

15. The interface cable of claim 14, wherein the first group of contact pins includes 10 pins and the second group of contact pins includes 6 pins, wherein first part is a universal serial bus (USB) 3.0 micro connector and the second part is a rectangular extension connector, wherein the first part and the second part share the same chassis of the housing.

16. The interface cable of claim 11, further comprises:
a second connector to provide a data interface connectivity; and
a plurality of conducting wires for coupling the first group of contact pins of the universal connector to a plurality of contact pins of the second connector, wherein the second group of contact pins of the universal connector are wired to the plurality of contact pins of the first connector.

17. The interface cable of claim 16, wherein the data interface connectivity provided by the first group of contact pins is of USB 3.0 and the multimedia interface connectivity provided by the second group of contact pins is of a DisplayPort interface.

18. The interface cable of claim 16, wherein the universal connector is any one of: a plug and a receptacle.

19. The interface cable of claim 11, wherein the first group of contact pins includes 5 contact pins and the second group of contact pins includes 5 contact pins.

20. The interface cable of claim 19, wherein the first part and the second part are enclosed in a housing of a micro USB 3.0 connector.
